(19) United States
(12) Patent Application Publication
(10) Pub. No.: US 2011/0146585 A1
(43) Pub. Date: Jun. 23, 2011

(54) Exercise weight for horses and other users

(76) Inventor: Harvey Tenenbaum, Toronto (CA)

(21) Appl. No.: 12/457,267

(22) Filed: Jun. 5, 2009

(51) Int. Cl. A01K 15/02; A63B 21/065

(52) U.S. Cl. 119/702; 482/105

(57) ABSTRACT

An exercise weight primarily for horses, to increase the horse's energy expenditure level during exercise. A slurry of polymerized plastic material is mixed with powdered metal, e.g. lead, producing a paste which is extruded in thin sheets, dried and cut to size. A selected number of such sheets are parallel stacked within a cover and can slide over each other to an extent limited by stitches or other fasteners holding the layers to the cover. The Young's Modulus of Elasticity (YME) of the resultant exercise weight is extremely low (typically less than about 2.5). The exercise weight can have various forms, such as the shape of a saddle to lie on the horse's body. When the horse gallops and its anatomical shape dynamically changes, the low YME permits the exercise weight on the horse to deform to adapt to the shape changes in the horse without generating large resistive forces or counterforces pushing against the horse. Avoiding these counterforces helps reduce injuries to the horse and allows better conditioning. The device weight can be increased by adding additional thin layers, up to but not substantially exceeding a critical number of layers, without substantially increasing the device's YME. The device can also be used for racing dogs, and other creatures, including humans.

### FIELD OF THE INVENTION

This invention relates to a unique exercise weight, which is intended primarily for horses but which can also be used for other living creatures, including humans.

### BACKGROUND OF THE INVENTION

The invention will be described primarily in connection with horses. However as noted, exercise weights according to the invention can also be used by humans and by other living creatures.

The benefits of exercise for improving physical and mental fitness have long been realized, and it is common to exercise horses (for example, race horses) to improve their physical fitness and to accustom the horse to working with trainers and riders. When a horse achieves improved fitness, its maximum running speed increases and its susceptibility to injury is reduced.

In the past, it has been common to exercise a horse with the help of individual persons. Such person(s) either leads (walks) the horse, or rides it at varying rates of speed. However, this requires considerable individual skilled labor and is costly. Therefore automatic exerciser machines have been developed and are now in common use and are marketed by a number of manufacturers. Automatic exercisers usually take the form of a rotating central portion having a vertical central axis. Long radial arms extend from the central portion. The central portion can be rotated at varying speeds, so that the arms move at speeds which can range from a walking speed to a moderate gallop. The machine usually has several radially extending arms, so that a horse can be connected to each arm and several horses can be exercised at the same time. Automatic exercisers have become popular and are often installed inside large arenas, where they can be used regardless of inclement weather.

A limitation to the benefits provided by automatic exercisers is that even though the speed and duration of the exercise can be and are varied, it is not possible to achieve more than a limited (although moderate) level of fitness of the horse at the speeds permitted by the equipment. It has therefore become widely known to increase the workload imposed on the horse during exercise by placing a weight or weights on the horse. Such weight(s) can simulate the weight of a rider, and in any event increase the exercise level to which the horse is subjected. The use of weight(s) is thus intended to increase the fitness level achieved by the horse. Examples of weights attached to horses for this purpose are shown in U.S. Pat. Nos. 4,369,967 and 4,709,621; and U.S. patent publication No. US2003/0092544.

Many other kinds of exercise weights have been developed for attachment to various parts of a body, for use by humans and others. Examples of weights designed for attachment to humans' shoes or feet are shown in U.S. Pat. Nos. 4,369,967 and 4,709,621; and U.S. patent publication No. US2003/0092544.

A major difficulty with all currently known weights for horses (and which difficulty has not previously been fully realized or understood) is that the weight materials used in such exercise weights all have some inherent stiffness, i.e. they all require some force to cause them to flex and undergo deformations in their shape. This creates a problem in use, because as the horse exercises (e.g. gallops), large dynamic changes in the horse's anatomical shape occur throughout the exercise period. If the weight system placed on the horse has a high resistance to elastic deformation, or if it has a highly non-uniform resistance to elastic deformation over the area of the weight system, then the weight system will require substantial force to be applied to it before it will “cooperate” by deforming into shapes which match the shape changes occurring in the horse during exercise. The horse will feel the forces needed to deform the weight system as being a set of resisting forces, i.e. a set of counterforces, from the horse's exercise weight. The areas of resistive forces or counterforce created by the exercise weight may cause small, reflex movements in the horse, such that parts of the horse's body move or recoil away from these areas of high resistive force or counterforce. These small reflexive movements by the horse can and commonly do alter the horse's natural stride. Even small distortions in the horse's natural stride can lead to injury, which is contrary to the objectives of the exercise. In addition, even if injury does not occur, the horse may tend to exercise in a more constrained manner, thus reducing the expected benefits of the exercise, such as improved cardiovascular and musculoskeletal development.

### BRIEF SUMMARY OF THE INVENTION

Therefore, it is an object of the present invention to provide an exercise weight which, because of its construction, has a superior ability to adapt and conform to the dynamic anatomical changes in shape of the horse which occur during movement of the horse. The exercise weight of the invention is constructed to have a very low resistance to elastic deformation in its shape (i.e. low Young's Modulus of Elasticity, or “YME”. In addition, such low YME is preferably (although not necessarily) relatively uniform over the area of the exercise weight. As a result, the exercise weight of the invention can improve aerobic ability and stimulate musculoskeletal development without the jarring, irregular and often erratic motion caused by a rider galloping the horse.

In one of its embodiments, the invention provides an exercise weight for attachment to a living creature, said weight comprising: a) a plurality of thin, sheet-like layers, each layer comprising a thermoplastic carrier material and a powdered metallic powder dispersed in said carrier material, b) each layer having a low Young's Modulus of Elasticity (hereinafter “YME”) so that each layer has a low resistance to deformation of its shape within an elastic range of deformation of said layer, c) said layers being stacked one over the other to form a stack of said sheets, d) a cover enclosing said stack of sheets and retaining them securely against separation from each other, with each sheet being slideable over sheets which are adjacent to it in said stack, within at least one or more localized areas, e) said sheets together providing a selected weight, such weight being predetermined as appropriate for the creature to which said exercise weight is to be attached for increasing the level of exercise of said creature, and f) an attachment device connected or adapted to be connected to said cover and adapted to be connected to attachment points for attaching said exercise weight to said creature.

Other objects and advantages of the invention will become apparent from the following description, taken together with the accompanying drawings.

### BRIEF DESCRIPTION OF THE DRAWINGS

In the accompanying drawings:

FIG. 1 is a diagrammatic perspective view of a horse exercise weight according to the invention, made in the form of a saddle;

FIG. 2 is a side sectional view of a portion of the horse exercise weight of FIG. 1;

FIG. 3 is a diagrammatic view showing production of a thin film weight layer used in the exercise weight of FIGS. 1 and 2;

FIG. 4A is a plan view of an exercise weight according to the invention and showing a stitching pattern for connecting the weight layers to the cover;

FIG. 4B is a plan view similar to FIG. 4A but showing a different stitching pattern;

FIG. 4C is a plan view similar to FIGS. 4A and 4B but showing a further stitching pattern;

FIG. 5 is a perspective view showing another embodiment of an exercise weight according to the invention;

FIG. 6 is a perspective view showing yet another form of exercise weight according to the invention;

FIG. 7 is a perspective view showing yet a further form of exercise weight according to the invention;

FIG. 8 is a perspective view of a modified exercise weight according to the invention; and

FIG. 9 is a side sectional view of the exercise weight of FIG. 8.

### DETAILED DESCRIPTION OF PREFERRED EMBODIMENT

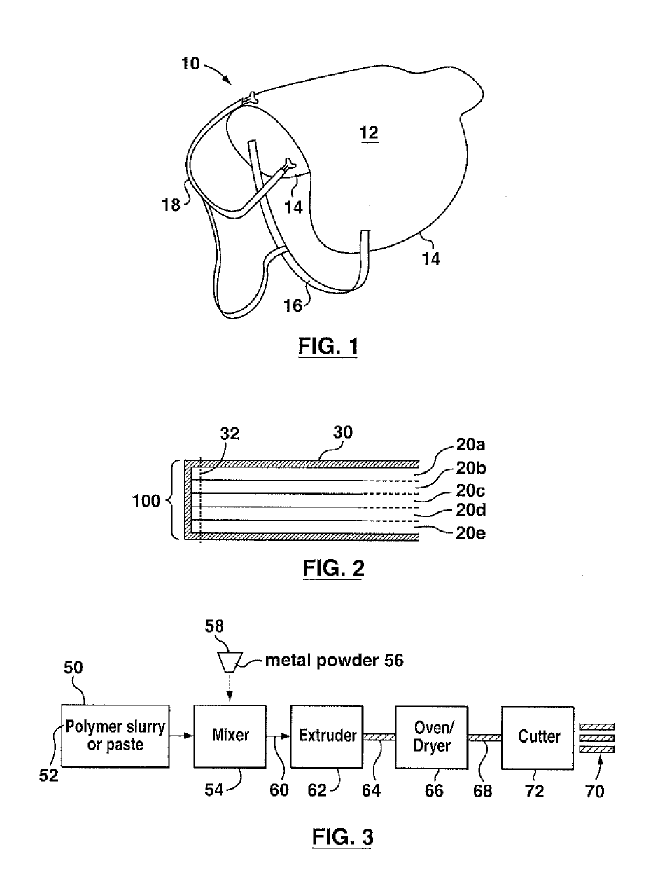

Reference is first made to FIG. 1, which shows a typical horse exercise weight 10 according to the invention, made in the form of a saddle. The exercise weight 10 may have a central section 12 which lies across the back of the horse, downwardly extending side sections 14 to which lie against the flanks of the horse, and may have a cinch strap 16 attached to central section 16, and a martingale strap 18 attached as shown, to secure the exercise weight 10 to the horse. The particular form selected for the external shape of the weight 10 and the straps may vary depending on the application, and other external shapes may also be used.

In the past, a typical implementation of the weight 10 would have been to use a fabric or similar material which would lie against the horse and which had pockets to hold the desired weights. That construction has several disadvantages, including a high degree of resistance to elastic shape deformation (a high YME) at the location of the weights in the weight pockets, and a highly non-uniform distribution of the structure's resistance to shape deformation when the horse gallops (as will be discussed).

The present invention in its preferred embodiments attempts to reduce or remove these problems and also to provide certain advantages. These will become apparent with reference to FIG. 2, which shows a preferred construction for weight 10 according to the invention. As shown in FIG. 2, an exercise weight 10 according to the present invention is constructed of a number of thin weight layers 20a to 20e of a special flexible weight material to be described. The layers 20a to 20e lie one over the other, in contact with each other. In FIG. 2, five such weight layers are shown, but a different number of layers can be used depending on requirements.

An important feature of the exercise weight 10 is that the weight layers 20a to 20e have a very low resistance to elastic deformation (as will be discussed) and are relatively freely able to slide over each other, subject to the constraint that the stack of weight layers is enclosed in a tightly fitted cover 30 (and is typically attached to the cover), as will be described. The cover 30 maintains the integrity of the overall shape of exercise weight 10 (e.g. in the saddle shape shown), but allows each layer 20a to 20e, to utilize its high flexibility capabilities (such capabilities result from the special construction of layers 20a-20e, as will be described). When the weight layers 20a to 20e are placed in the cover 30, or before then, a lubricant such as a silicone spray or dusting of cornstarch is preferably placed between each layer to maximize the freedom of movement of the layers to slide over each other in an independent manner in small localized areas, but not at the edges of the cover. At the edges of the cover, the layers 20a to 20e may be sewn to each other or to the cover 30, as shown by stitches 32, to prevent the layers 20a to 20e from buckling within the cover.

The cover 30 can be made of woven or non-woven fabric which is made to be anti-slip and yet of a non-irritating material so that it is comfortable while in contact with the skin of the horse. After the fabric for cover 30 is made, it is preferably coated with liquid polyurethane in an extremely thin layer (about 2 mil, where 1 mil=0.001 inch). The liquid polyurethane does not adversely affect the low resistance to elastic deformation of the exercise weight 10 in a material way, but helps to protect the weight 10.

The cover 30 is also treated before use with a permanent anti-bacterial compound incorporated into the fabric, to minimize the possibility of cross-infection between horses. Suitable anti-bacterial compounds include chitosan, nano-silver, and quaternary ammonium compounds.

The very low resistance of each weight layer 20a to 20e to elastic deformation, while at the same time ensuring that each weight layer is heavy enough to perform acceptably, is of key importance in the invention. A generally accepted measure of the property of a material to deform within an elastic range is Young's Modulus of Elasticity (“YME”). YME is a very well-known parameter and has been measured for many materials. YME is defined as the ratio of stress to strain, where stress is the force which produces a given strain (i.e. a given deformation) of a material under standard environmental conditions, and so long as the material is in an elastic range where removal of the stress will result in removal of the strain so that the material assumes its original non-stressed shape. (Minor factors such as hysteresis are not be taken into account for purposes of this discussion.)

In order to interfere as little as possible with the horse's movements, the YME of the exercise weight 10 used should be as low as possible. However, the exercise weight 10 also should be heavy enough to create an adequate “workout” for the horse. In addition the YME of the material used should preferably be relatively uniform over the area of the exercise weight. Non-uniformities in the YME of the exercise weight 10, particularly large non-uniformities in YME in which the gradient or rate of change between low and high YME is steep (i.e. the YME changes rapidly) may cause injury to the horse. However some non-uniformities in YME, depending on their location, size, and rate of change of YME at the boundary between low and high YME areas, are acceptable.

Another factor to be considered is that when a heavier weight is needed, how can the YME of such heavier weight be kept low. Usually when a heavier exercise weight is needed, the thickness of the weight is simply increased. However when the thickness of a layer of weight material increases, the YME of the layer also increases. A too large increase in the YME of the weight layer would be undesirable.

Taking the above factors into account, it is found that the exercise weight of the invention should be formed from a number of individual thin layers, as described above in connection with FIG. 2. With this arrangement, if more weight is needed, the individual weight layers 20a to 20e do not need to be made thicker. It is necessary only to add more weight layers. If the individual layers 20a to 20e are sufficiently thin, and are laid in a stack of parallel layers, one layer over another, so that the layers are slidable relative to each other (except at restraining areas such as the edges) then the resulting exercise weight has a much lower YME then a single weight layer of the same total thickness would have. However, it is also found that when the weight layers 20a to 20e are stacked, there is about a 5% increase in YME (i.e. in the force needed to produce a given elastic deformation) for each layer added after the first. When more than ten layers were used in the stack, a dramatic increase in the YME of the stack of layers was observed. For example, the YME produced by using 10 layers instead of 7 layers would have been expected to be 15% greater than the YME produced using 7 layers, but was actually found to be 30% higher. Therefore, there are practical limits to the number of layers that can be used in a stack. Beyond a critical number of layers, the YME of the stack may increase rapidly and non-linearly. Therefore the number of layers used in each application should not exceed the critical number. The critical number may vary from case to case but can easily be determined by experimentation. In the example given, the critical number was seven.

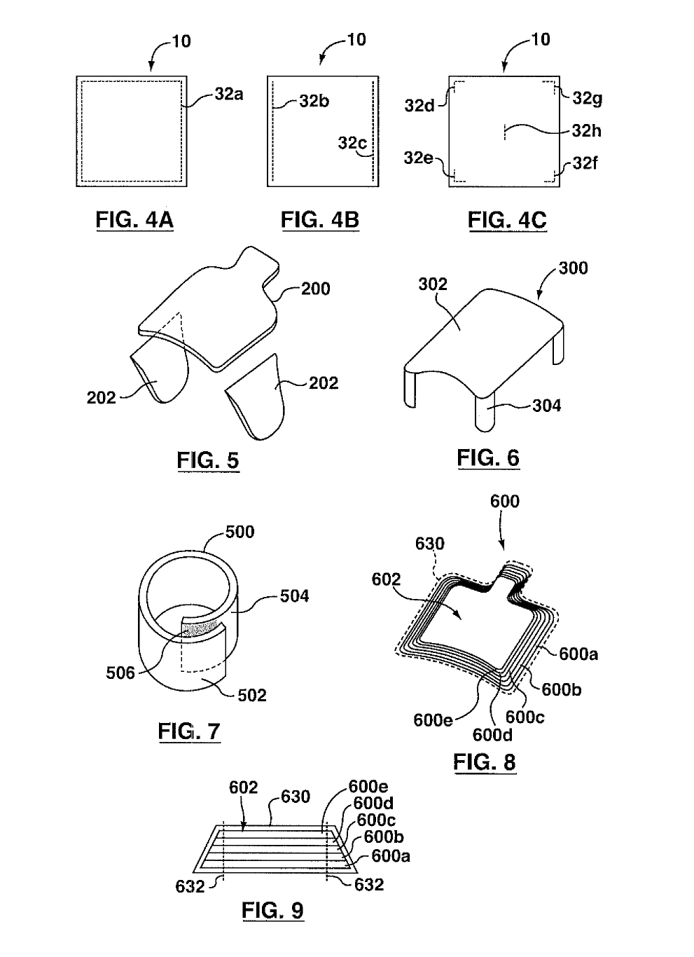

Reference is next made to FIGS. 3, 4 in connection with which preferred materials and methods for making the weight layers 20a to 20e will be described. It is found that each weight layer 20a to 20e is advantageously made using a base or matrix material which is a thermoplastic polymer. An example of such material is polyvinyl chloride (PVC). Various types of polymers and polymerizing agents may be used, if desired in the presence of an emulsifier and with additives such as phthalates to enhance softness and flexibility. Various surfactants can be added to assist in polymerization.

The monomer used in polymerization may be vinyl chloride or mixtures of vinyl chloride with ethylenically unsaturated monomers or other suitable material. Polymerization is usually carried out in special pressure reactors used for the production of polyvinyl chlorides.

FIG. 3 shows a sequence of steps which may be used in the production of the thin weight layer films 20a to 20e of FIG. 2. The polymerization may occur in reactor vessel 50, and results in the production of a slurry or paste 52 which is directed to a mixing vessel 54. In mixing vessel 54, one or more powdered metals 56 ground to an appropriate mesh size and supplied from a source shown as hopper 58, are added to the slurry or paste 52. The powdered metal(s) 56 is/are thoroughly mixed into the slurry or paste in mixing vessel 54, so that the powdered metal(s) is/are uniformly distributed in such slurry or paste. The kind of metal or metals and the amount of such powdered metal(s) used will depend on the weight needed.

From mixing vessel 54, the slurry or paste 60 of powdered metal/polymer is transferred to an extruder 62, where it is extruded as a wide thin film 64. The film 64 can be of any commercially practical width desired, depending on the design and width of the extruder 62. After the film 64 leaves extruder 62, it is cured in an oven 66, either by flash drying or by heating in the oven. The finished film, shown at 68, is then cut into sheets 70 of the desired size by a cutter 72. The cut sheets 70 produced at the cutter 42 can either be, or can be cut into, the weight layers 20a to 20e of FIG. 2.

The powdered metal incorporated into the sheets 70 can be various metals or combinations of metals, including steel, lead, tin, antimony, and any other appropriate metal. Since each granule of metal is completely and permanently covered by the liquid polymerized plastic material 52, the extruded sheets 70 do not have any exposed metal which could contact the air or the skin of a horse or other animal or person being exercised or handling person. A preferred metal for use in the sheets 70 is lead, since it is very dense.

It is found that the metal used should be ground to a very fine powdered condition, with the best mesh size for the powdered metal being about 325. However, the mesh size used for the powdered metal can range between about 250 and 400 mesh.

The thickness of the extruded film 70 (i.e. of the sheets 70) for use in exercise weights for horses is preferably about 25 mil (1 mil=0.001 inches). The film thickness can range from about 5 mil to about 30 mil, depending on the total weight desired for the sheets when used. More preferably the thickness of each film or weight layer 20a to 20e is between about 20 mil and 30 mil, and as stated above, the best thickness (for horse exercise weights) is about 25 mil. If the film thickness is too large, the YME of the weight layer will be too high. If the film thickness is too low, the weight layers 70 will not be heavy enough and too many layers will need to be stacked, thus also causing the YME of the resultant exercise weight to be too high (because of the large number of layers needed).

The weight per square foot of each 25 mil thick film extrusion depends (as noted) on the type of metal or metal blends used, and may vary from 0.67 lbs to 0.41 lbs as a preferred range. In this range, the individual film sheets 70 have very high flexibility (low YME), and as more layers are added to the stack of layers used in exercise weight 10, the ability of weight 10 to deform in shape elastically, with low resistance, in response to dynamic deformation of the horse's shape is only slightly diminished. However, once more than seven layers are combined, the resistance to reshaping increases approximately 5% with each additional layer.

When exercise weight 10 is made for use on a typical horse, the weight 10 has approximately 24 sq. ft. of extruded film 70 in each layer 20a to 20e. (Each layer 20a to 20e is of course a single layer.) Since the weight per square foot for such film assuming that film of 25 mil. thickness is used) is about 0.67 lbs, each weight layer 20a to 20e will weigh about 18 lbs (i.e. 0.67×24 for a 24 sq. ft. layer).

When the exercise weight 10 is used, to exercise typical horses, the exercise weight 10 should preferably weigh between 60 to 100 lbs, and more preferably between about 80 lbs to 90 lbs. This will require the use of five layers 20a to 20e overlying and parallel to each other in a stack 100, as shown in FIG. 2 (assuming that each 24 square foot layer weighs 18 pounds, as described). In construction of the exercise weight 10, the film layers 20a to 20e are cut and shaped to fit the anatomy of the horse. As previously noted, a lubricant such as a silicone spray or dusting of cornstarch may be placed between each layer 20a to 20e (preferably before the layers are inserted into the cover 30) to maximize the freedom of the layers to slide over each other, subject to the constraints described below.

Because the weight layers 20a to 20e are so flexible, they may tend to buckle or otherwise move within the cover 30, even though the cover 30 encloses the weight layers 20a to 20e very snugly. To prevent such buckling from occurring, it is preferred that the weight layers 20a to 20e be secured to the cover 30, but in a way that will permit the layers 20a to 20e to slide over each other as much as possible. The ability of the weight layers 20a to 20e to slide over each other helps reduce the “stiffness” of the overall weight 10, i.e. it reduces the resistance of exercise weight 10 to elastic deformation.

FIGS. 4A, 4B and 4C illustrate several ways of attaching the layers 20a, 20b to the cover 30 while still permitting some sliding of the layers over each other in areas between the points of attachment. In FIG. 4A, the layers 20a to 20e are shown with their edges sewn together and to the cover 30, by a line of stitches 32a which extend around the entire perimeter of the weight 10. FIG. 4B is similar to FIG. 4A but shows two lines of stitches 32b, 32c which are located only along opposite edges of the weight 10. If the area of weight 10 is not unduly large in area, then sewing only two opposing edges together is sufficient to hold layers 20a to 20e in proper position within the cover 30. Since the remaining two edges of weight 10 are not stitched, the layers 20a to 20e have more freedom to slide back and forth over each other.

In FIG. 4C, stitching of the layers 20a to 20e to the cover occurs only at the corners of the cover as shown at 32d, 32e, 32f, 32g, and optionally at a short line 32h in the center of the weight 10. This will also prevent the weight layers 20a to 20e from buckling and moving about inside the cover 30, while permitting some sliding of one layer over the other in areas between the sets of stitches. Various other stitch patterns can be used, depending on the size and shape of the exercise weight 10, to prevent the weight layers 20a to 20e from moving about to an undue extent, or buckling within the cover 30, while still permitting as much sliding as possible of the weight layers 20a to 20e over each other.

As previously mentioned, it is found that when a horse carries an exercise weight which is relatively stiff, then during the horse's motion, as muscular contractions occur and as the horse's anatomical shape dynamically changes and exerts shape changing forces on the exercise weight, areas of resistive forces or counterforce will occur at various locations on the exercise weight. At these areas, the resistive forces or counterforce push against the horse's body. As noted, this causes minute involuntary reflex reactions in the horse, as the horse involuntarily attempts to reduce the unpleasant resistive forces or counterforce at the areas when the weight is stiff. These minute reflex adjustments of the horse's body may be sufficient to alter the horse's natural stride. Such minute adjustments and stride alterations can result in subclinical soft tissue injuries which can compound themselves with later rigorous training.

The use of the exercise weight 10 of the invention, which has a low YME, reduces the tendency of the exercise weight to create counterforces or resistive forces which act against the natural shape changes that occur in the horse's body during exercise such as galloping. For this purpose, preferably the YME of the exercise weight 10 is less than 2.7, and more preferably it is less than 2.5. This low YME can easily be achieved by using the weight layer design described above. The design described also permits the total weight of the exercise weight to be increased as necessary, simply by adding additional layers. Provided that the total number of layers used does not exceed (or at least does not exceed by more than a few layers) the critical number at which the YME increases rapidly, the extra layers reduce the YME only minimally.

The exercise weight shown in FIG. 1 can take various external forms, depending on the application. For example, as shown in FIG. 5, the exercise weight can have a smaller central saddle shaped portion 200, with two additional side sections 202 which are removably attached one to each side of the central saddle. Any conventional removable attachment system can be used for connecting the parts. The well-known attachment system sold under the trade-mark Velcro® is preferably used. With this arrangement, the trainer can begin the horse's training using initially only the central saddle shaped section 200 (which may for example weigh 60 lbs). Then, when the horse has acquired some conditioning, the two side sections 202 (which may each weigh about 10 pounds) can be added.

While the invention has been described in connection with an exercise weight for horses, the system of the invention can be used for exercising other types of living creatures. For example, it can be used in exercising dogs, such as greyhound racing dogs. The concepts described above for use in the dog exercise weight 300 (FIG. 6) do not change from those described above. However, since dogs are usually much smaller than horses, the exercise weight sheets or layers to be extruded will usually be smaller and thinner than layers 20a to 20e but will provide the necessary amount of weight to form a composite weight for a dog such as a greyhound. The thickness of each weight layer will depend on how many individual weight layers are needed to achieve the desired total weight to be secured to the dog for conditioning and exercising the dog. For example, as shown in FIG. 6, the dog exercise weight 300 may have a simple “blanket” shaped central section 302, with four downwardly extending leg sections 304, one on each corner of the central section 302. The leg sections 304 can be strapped to the dog's legs. As before, the individual weight layers used in exercise weight 300 will be stacked parallel to each other (in the manner shown in FIG. 2), and will be constrained by a cover such as cover 30. As before, the weight layers will be relatively free (except at their edges or other selected parts) to slide over each other. Preferably lubricant and anti-bacterial sprays will be used as previously described, and preferably the cover of dog exercise weights will be waterproofed by being sprayed with a very thin layer of polyethylene or polypropylene.

The exercise weight of the invention can also be used for humans, in applications where low stiffness (low YME) is desired. For use on humans, a layered exercise weight according to the invention may be formed to fit over any desired part of a person's anatomy. For example, the layered exercise weight of the invention may be used to make a vest or other piece of clothing to be worn by a person, covering a desired area of the person's body. Alternatively, the layered exercise weight of the invention can simply take the well known form of a band 500 (FIG. 7), the ends 502, 504 of which can be placed one over the other and can be secured together by a hook and loop fastener 506, such as Velcro® (trademark). The band 500 may have any desired number of weight layers, depending on the total weight needed and also subject to the constraint described above, that the number of layers used should be less than the number at which rapid non-linear increases in YME occur. The band 500 will normally be wrapped around and held to the wearer's ankle or wrist, but it can be applied to any body part (even to the wearer's waist if this were thought to be helpful). An advantage of using the above described layered, low YME exercise weight is that it adapts unusually well to the wearer's body, and it reduces the tendency of conventional weights worn on the body to create pressure points. The weight distribution, and even the YME, will not be uniform over the entire area of the band 500; instead, there will be a weight increase and a YME increase where the ends 502, 504 of the band 500 overlap. This non-uniformity is not a problem for humans so long as it remains within reasonable limits.

It should be realized that even for horses and other creatures that are sensitive to uneven distribution of weight and YME over the area of the exercise weight, some fluctuations of these parameters over the area of the layered exercise weight can be tolerated. Thus, for example, the central saddle shaped portions 200 shown in FIG. 5 can have a different number of weight layers than the side portions 202. For example, central portion 200 can have five weight layers 20a to 20e, while the side portions can have (by way of example) eight weight layers. (Alternatively, depending on the needs of the application, the ratios can be reversed, and the central portion can have eight weight layer, while the side portions 202 can each have five weight layers.) This allows the weight to be distributed in a desired manner over the horse's body. The ability to vary the number of weight layers (e.g. layers 20a to 20e) in various portions of the exercise weight 10 allows the exercise weight 10 to be tailored to the needs of an individual horse, or to the needs of horses in general.

In the design process for exercise weight 10, it will be understood that as many or as few stacks of weight layers as desired may be used in the exercise weight 10, and that some stacks may differ in length, width or thickness from other stacks used in the exercise weight. For example, in FIG. 1 it has been assumed that only one stack of weight layers 20a to 20e is used, and that each weight layer extends over the entire area of the exercise weight 10. However the exercise weight 10 can be formed from multiple stacks of weight layers, the stacks being attached side-by-side to each other. The attachment of a stack to an adjacent stack can be by attaching the covers together at their edges, e.g. by stitching. Alternatively, multiple stacks of different sizes can be located side-by-side and stitched to the same cover. As another alternative, and as shown in FIG. 5, an entire stack and its cover can form each section of the exercise weight. For example, side portions 202 and control portion 200 together constitute three separate stacks, each with a cover, and with side-by-side attachment provided by Velcro® (trademark) straps.

When stacks which are located side-by-side have different YME values, e.g. because the stacks have different numbers of weight layers, then preferably the boundary between the stacks with different YME should be at a location on the horse's body where the discontinuity (i.e. the change in weight and in YME from one stack of weight layers to another) is not too large and will not cause any harmful effects on the horse. In the example given, the discontinuity in YME caused by going from a five layer to an eight layer exercise weight is not large (only about 15%), and hence is unlikely to cause harmful effects even in a sensitive race horse.

While it has been assumed that the weight layers 20a to 20e within any given cover 30 (and forming a stack) are all of the same size (i.e. all of the same length, width and thickness), this is not necessarily the case. Reference is made, to FIGS. 8 and 9, which show an exercise weight 600 which is similar in size and shape to the central saddle shaped portion 200 shown in FIG. 5. However FIGS. 8 and 9 illustrate that if desired, some or all of the layers 600a to 600e in the stack of layers 602 located inside the cover 630 can have different length and width dimensions from the other layers in the stack. For example, if it is desired to taper the weight of the stack 602 at its edges, then each successive layer 600a to 600e can have a smaller length and width then the adjacent layer below it on which it sits. The cover 630 also tapers inwardly at its edges, as shown at 634 in FIG. 9. The stitches 632 which hold the layers 600a to 600e to the cover and prevents it from buckling are moved inwardly slightly toward the center of the stack, so that they will hold in place the smallest layer 600e, as well as the largest layer 600a.

The weight layers 600a to 600e can also have different thicknesses from each other. For example each successive layer can be slightly thinner than the adjacent layer on which it sits. Thus, layer 600a will be thicker than layer 600b, which in turn will be thicker than layer 600c, etc. However the variation in thickness feature must be carefully used, since thicker layers tend to be undesirably stiff (i.e. they may have a high YME). It is preferable to have more thin layers than to have fewer but thicker layers, provided that the total number of layers in a stack does not substantially exceed the critical number mentioned.

In summary, as will be seen, the various adjustable parameters available for use by the designer of the exercise weight provide the designer with a number of tools that he/she can use to adapt the finished weight to the needs of the horse or other creature for which the exercise weight is to be used. This ability to adjust the design parameters largely results from the feature that the exercise weight is assembled from a number of thin individual layers arranged in a parallel stack so that to at least a limited extent they can slide over each other, and with each layer formed in the manner and from the materials as described. Thus, in all cases each weight layer is thin, flexible (low YME) and provides sufficient weight to meet the objectives of the described exercise weight.

While preferred embodiments of the invention have been described, it will be realized that various changes may be made within the scope of the invention, and all such changes, modifications and improvements are intended to be within the scope of the invention.

1. An exercise weight for attachment to a living creature, said weight comprising:
a) a plurality of thin, sheet-like layers, each layer comprising a thermoplastic carrier material and a powdered metallic powder dispersed in said carrier material,
b) each layer having a low Young's Modulus of Elasticity (hereinafter “YME”) so that each layer has a low resistance to deformation of its shape within an elastic range of deformation of said layer,
c) said layers being stacked one over the other to form a stack of said sheets,
d) a cover enclosing said stack of sheets and retaining them securely against separation from each other, with each sheet being slideable over sheets which are adjacent to it in said stack, within at least one or more localized areas,
e) said sheets together providing a selected weight, such weight being predetermined as appropriate for the creature to which said exercise weight is to be attached for increasing the level of exercise of said creature, and
f) an attachment device connected or adapted to be connected to said cover and adapted to be connected to attachment points for attaching said exercise weight to said creature.

2. An exercise weight according to claim 1 wherein there are at least three said layers.

3. An exercise weight according to claim 1 wherein there are at least five said layers.

4. An exercise weight according to claim 3 wherein each layer is of the same length, width and thickness as each other layer in said stack.

5. An exercise weight according to claim 2 wherein each layer is of thickness between 20 mil and 30 mil.

6. An exercise weight according to claim 5 wherein each layer is of thickness approximately equal to 25 mil.

7. An exercise weight according to claim 1 wherein said thermoplastic is selected from the group consisting of polyethylene plastics and polyvinyl chloride plastics.

8. An exercise weight according to claim 1 wherein said powdered metal consists primarily of lead.

9. An exercise weight according to claim 1 wherein said powdered metal is present in a proportion such that the YME of each layer does not exceed approximately 2.5.

10. An exercise weight according to claim 1 wherein said powdered metal has a mesh size of between 250 and 400.

11. An exercise weight according to claim 10 wherein the mesh size of said powdered metal is approximately 325.

12. An exercise weight according to claim 1 wherein the weight of each layer is approximately 0.67 lbs per square foot and each said layer has a thickness of between 5 mil and 25 mil.

13. An exercise weight according to claim 12 wherein said thickness is approximately 25 mil.

14. An exercise weight according to claim 1 wherein the number of said layers does not exceed 7.

15. An exercise weight according to claim 1 wherein each layer in said stack has approximately the same length, width and thickness as each other layer in said stack.

16. An exercise weight according to claim 1 and including a lubricant between each said layer, to improve the ability of each layer to slide over an adjacent layer at said localized areas.

17. An exercise weight according to claim 1 wherein said cover is a thin, tightly woven and highly flexible fabric, said cover being treated with an anti-bacterial compound to reduce the likelihood that said cover may pick up and retain bacteria from a creature wearing the exercise weight.

18. An exercise weight according to claim 17 wherein said fabric is coated with a thin film of plastic material, to reduce the likelihood of water and sweat permeating through said cover.

19. An exercise weight according to claim 1 and intended for use with a horse, each layer being of thickness approximately equal to 25 mil and having an area of approximately 20 sq. ft. to 24 sq. ft. and a weight of approximately 0.67 lbs per square foot, each layer thereby having a weight of between about 13 lbs and 18 lbs, said stack of layers comprising approximately 5 layers.

20. An exercise weight according to claim 19 wherein said stack of layers and said cover have substantially the shape of a saddle or a portion of a saddle.

21. An exercise weight according to claim 18 wherein there are five said layers throughout said exercise weight, so that the distribution of weight and of the YME of said exercise weight are uniform throughout at least a substantial portion of the area of said exercise weight, said YME being less than about 2.7.

22. An exercise weight according to claim 21 wherein the YME of said weight is less than about 2.5.

23. An exercise weight according to claim 1 and having the shape of a garment or a portion of a garment adapted to be worn by and attached to a human being.

24. An exercise weight according to claim 23 and having a YME of not more than about 2.5.

25. An exercise weight according to claim 1 wherein the number of said layers does not exceed a critical number above which the YME of said stack tends to increase rapidly and non-linearly.

26. An exercise weight according to claim 1 wherein the number of said layers does not exceed by more than about three, a critical number above which the YME of said stack tends to increase rapidly and non-linearly.
